(19) United States
(12) Patent Application Publication
(10) Pub. No.: US 2006/0122284 A1
(43) Pub. Date: Jun. 8, 2006

(54) Well dispersed polymer nanocomposites via interfacial polymerization

(75) Inventors: Fernando J. Rodriguez-Macias, San Luis Potosi (MX); Enrique V. Barrera, Houston, TX (US)

Correspondence Address: Robert C. Shaddox;Winstead Sechrest & Minick P.C., P.O. Box 50784, Dallas, TX, 75201, US

(73) Assignee: William Marsh Rice University, Houston, TX (US)

(21) Appl. No.: 11/294,883

(22) Filed: Dec. 2, 2005

Related U.S. Application Data
(60) Provisional application No. 60/633,054, filed on Dec. 3, 2004.

(51) Int. Cl. C08J 9/26

(52) U.S. Cl. 521/61

(57) ABSTRACT

The present invention is generally directed to methods of in situ dispersion of nanosized materials (nanomaterials) in polymer hosts during the interfacial synthesis of said polymers. Such methods can generally comprise the steps of: (a) suspending a quantity of nanomaterials in a non-polar solvent (e.g., organic) to form a non-polar suspension; (b) dissolving a quantity of a first monomer species in the non-polar suspension to form a non-polar reactant phase; (c) dissolving a quantity of a second monomer species in a polar (e.g., aqueous) solvent to form a polar reactant phase; and (d) contacting the polar reactant phase with the non-polar reactant phase so as to effect interfacial polymerization, wherein such interfacial polymerization yields a composite product comprising nanomaterials well-dispersed in a polymer or copolymer matrix. Alternatively, the nanomaterials can be suspended in the polar solvent.

### CROSS-REFERENCE TO RELATED APPLICATIONS

This Application for Patent claims priority to U.S. Provisional Patent Application Ser. No. 60/633,054, filed Dec. 3, 2004.

The present invention was made with support from the National Aeronautics and Space Administration, Grant No. NASA URETI NCC-1-0203; and the Robert A. Welch Foundation, Grant No. C-1494.

### FIELD OF THE INVENTION

This invention relates generally to polymer materials comprising nanomaterials, and specifically to methods of making such polymer materials via methods of interfacial polymerization.

### BACKGROUND OF THE INVENTION

Interfacial polymerization is a well known technique, and a simple process, that can be carried out at room temperature, and which only requires vigorous mixing of an aqueous and an organic phase, and control of the concentrations of chemicals in those phases, to achieve high molecular weight and high yields. It is useful for several condensation polymers such as polyamides, polyphtalamides, polyurethanes, polyesters, polysulfonamides and polythiolesters, as well as for copolymers.

Typically, a difunctional monomer (-AA-) will be dissolved in the aqueous phase, together with a base when necessary to react with acid byproducts, or with another suitable chemical substance that can remove byproducts to increase the yield. The other difunctional monomer (-BB-) is dissolved in the organic phase. The reaction occurs rapidly at the interface between the aqueous and the organic phase, as the AA monomer diffuses into the organic phase, resulting in an (-AA-BB-)ₙ polymer. It is also possible to have a monomer with both functional groups (-AB-) in the organic phase, the polymerization then occurs as the byproducts diffuse into the aqueous phase and react with the appropriate species. The rapid reaction tends to create a film of polymer at the interface which limits the diffusion of monomers and byproducts, this requires stirring to provide shear and breaks the film allowing the reaction to proceed until a high yield is achieved. The technique can also be applied directly to create thin polymer films and membranes without stirring.

Interfacial polymerization can be a batch process, where the two phases are stirred vigorously and after a few minutes the reaction is complete and the polymer or composite can be filtered, washed to remove unreacted monomers and/or byproducts, or otherwise processed. The technique can also be adapted to a continuous process with a suitable reactor that has a continuous feed of both phases passing through a region of high shear stirring, and the resulting slurry with the product filtered, or otherwise processed, afterwards.

In view of the above-described facile processing, a method of using interfacial polymerization to make nanomaterial/polymer composites and blends would be quite useful.

### BRIEF DESCRIPTION OF THE INVENTION

The present invention is generally directed to methods of in situ dispersion of nanosized materials (nanomaterials) in polymer hosts during the interfacial synthesis of said polymers. Such methods can generally comprise the steps of: (a) suspending a quantity of nanomaterials in a non-polar solvent (e.g., organic) to form a non-polar suspension; (b) dissolving a quantity of a first monomer species in the non-polar suspension to form a non-polar reactant phase; (c) dissolving a quantity of a second monomer species in a polar (e.g., aqueous) solvent to form a polar reactant phase; and (d) contacting the polar reactant phase with the non-polar reactant phase so as to effect interfacial polymerization, wherein such interfacial polymerization yields a composite product comprising nanomaterials well-dispersed in a polymer or copolymer matrix. Alternatively, the nanomaterials can be suspended in the polar solvent.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates, in flow diagram form, methods for dispersing nanomaterials in polymer matrices via interfacial polymerization and in accordance with some embodiments of the present invention.

### DETAILED DESCRIPTION OF THE INVENTION

The present invention is generally directed to novel processes that provide a new approach to achieving good in situ dispersion of nanosized materials (nanomaterials) in polymer hosts during the interfacial synthesis of said polymers, as described above. In some embodiments, this is accomplished by dispersing the nanomaterials in the organic phase of the processes described above. The resulting composite integrates the nanomaterials with excellent and uniform dispersion without the need for further processing, but additional processes are possible depending on the final product desired. Described herein as an exemplary embodiment is a method for producing polyamides (such as nylon) with nanotubes and dispersed nanotubes, as well as functionalized nanotubes. Two new exemplary such polyamide systems with nanotubes are described within the context of embodiments of the present invention, wherein such invention embodiments provide a basis for integrated polyamide composites with nanotubes and a basis for integrated polymer composites with nanotubes.

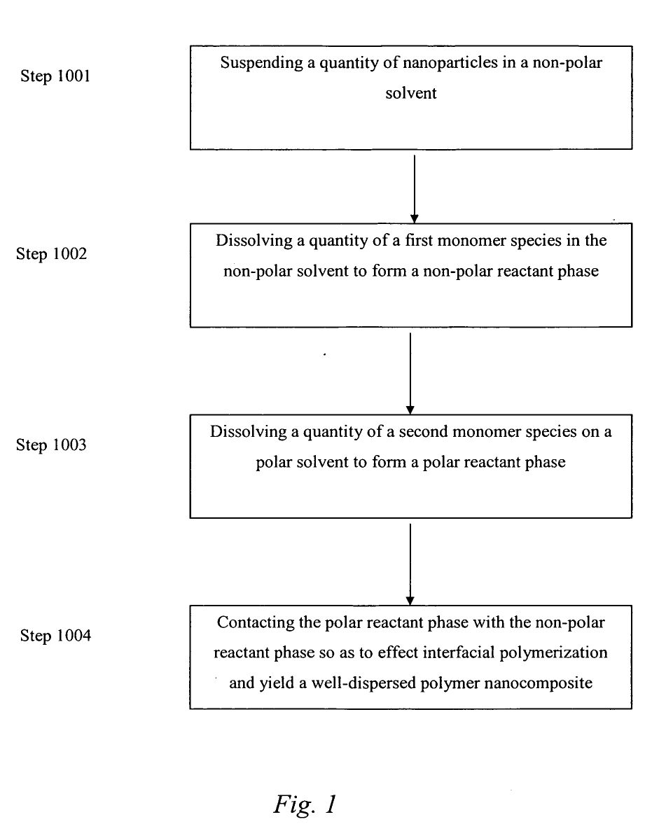

Referring to FIG. 1, methods of the present invention generally comprise the steps of: (Step 1001) suspending a quantity of nanomaterials in a non-polar solvent (e.g., organic) to form a non-polar suspension; (Step 1002) dissolving a quantity of a first monomer species in the non-polar suspension to form a non-polar reactant phase; (Step 1003) dissolving a quantity of a second monomer species in a polar (e.g., water) solvent to form a polar reactant phase; and (Step 1004) contacting the polar reactant phase with the non-polar reactant phase so as to effect interfacial polymerization, wherein such interfacial polymerization yields a composite product comprising nanomaterials well-dispersed in a copolymer matrix. Alternatively, the nanomaterials can be suspended in the polar solvent.

Nanomaterials, according to the preset invention, are generally any material that is nanosized (i.e., less than about 100 nm) in at least one dimension, but is typically nanosized in at least two dimensions. Such materials can be in the form of nanotubes, nanorods, nanosheets, nanoclays, nanoparticles (e.g., ceramic, semiconducting, or metallic), nanospheres, nanoshells, nanoscrolls, fullerenes, dendrimers, vapor-grown carbon fibers (VGCFs) and combinations thereof. Exemplary such materials include, but are not limited to, carbon nanotubes, the carbon nanotubes being single-wall carbon nanotubes (SWNTs), multi-wall carbon nanotubes (MWNTs), or both. The terms “nanomaterials” and “nanoparticles” will be used synonymously herein.

Typically, the polar solvent is water, but could generally be any polar solvent. Suitable polar solvents include, but are not limited to, water, alcohols, glycols, acetonitrile, and combinations thereof. Typically, the non-polar solvent is an organic solvent generally selected from aromatic solvents, aliphatic solvents, and chlorinated organic solvents. Such organic solvents include, but are not limited to, benzene, toluene, xylene, mesitylene, o-dichlorobenzene (ODCB), tetrachloroethylene, and combinations thereof. Generally, it is of primary importance that the polar reactant phase and the non-polar reactant phase are suitably immiscible with each other such that they allow for interfacial polymerization in accordance with invention embodiments. As such, there may be some instances where two polar, or, alternatively, two non-polar solvents will work to the extent that they are immiscible with respect to each other. In some embodiments, a surfactant may be used to facilitate suspension of the nanomaterials in either the polar or non-polar solvent. In some embodiments, chemical derivatization is used to alter the surface energy of the nanomaterials so as to facilitate their dispersal in either of the two immiscible solvent reactant phases.

Monomer choice is largely dependent upon the desired polymer or co-polymer product, as well as the solubility/compatibility of the monomer in polar/non-polar solvents utilized. When the first monomer species (designated as the species that is initially dissolved/suspended with the nanomaterials) is dissolved in a non-polar solvent, suitable first monomer species include, but are not limited to, dicarboxylic acid chlorides, disulfonyl chlorides, phosgene, bischloroformates, and combinations thereof. Suitable second monomer species include, but are not limited to, diamines, di-alcohols, diphenols, dithiols, and combinations thereof. When the nanomaterials are initially dispersed in a polar solvent, such suitable first and second monomer species are reversed.

In some embodiments, after interfacial polymerization, one or more post-polymerization steps can be carried out. One such step involves removing the solvent from the composite product. In some embodiments, this entails a filtration process. In some embodiments, there is an additional step of washing the composite product. In some embodiments, there is a step of processing the composite product with traditional thermoplastic processing techniques, such as fiber spinning.

In embodiments where there are nanoparticles present in the non-polar or organic phase, they incorporate into the polymer as it is synthesized. Given a good dispersion of nanomaterials in the organic phase, a similarly good dispersion will be achieved in the resulting composite. If the nanomaterial dispersion is not optimal, it could be improved by further processing, but this will not be necessary in most cases. The concentration of nanoparticles (nanotubes, nanoclays, etc.) in the composite can very easily be controlled by adjusting their concentration in the organic phase.

In some embodiments, polyamide-nanotube composites synthesized according to methods of the present invention incorporate well-dispersed nanotubes and/or integrated nanotubes with chemical bonding into the polymer matrix, resulting in composites with improved mechanical, electrical and thermal properties. An exemplary such composite is single-walled carbon nanotubes with polyamides (nylon). The polyamide composite materials so produced have improvements in their mechanical, thermal and electrical properties due to the dispersion of nanotubes and the presence of chemical bonds between the nanotubes and the polyamide in the integrated composites.

Methods of the present invention can provide for composites/blends comprising any of a variety of other nanomaterials in a great variety of polymer matrices. The resulting composites can have applications in many fields, such as reinforced fibers, fire retardant composites, etc. depending on the reinforcement used. Given the great diversity of polymers and nanomaterials that can be combined, the methods of the present invention can open the door to many applications with further research and development. The methods described herein should also be extendable to microparticles, not only to nanomaterials.

The in situ incorporation of nanomaterials into polymers during the synthesis by interfacial polymerization has not been reported previously in the literature. The processes described herein offer a short route to a wide variety of polymer nanocomposites, achieving good dispersion during the synthesis with no further processing. However, the resulting materials can be subject to additional processing to modify their composition, and to any processing required for the final applications, such as molding, fiber spinning, etc. The methods of the present invention can be especially useful in allowing the incorporation of nanomaterials into polymers that are generally susceptible to thermal degradation, where melt mixing is not possible. It also allows very easy control of the loading of nanoparticles in the composite.

It is important to emphasize that, in addition to polyamide-based nanocomposites, such composites can be made with any other polymer or co-polymer that can be synthesized by interfacial polymerization, including, but not limited to polyurethanes, polyphtalamides, polyesters, and polysulfonamides. In some cases only one bifunctional monomer can be used, in the organic phase, with another reactant in the aqueous phase that will neutralize the byproducts or catalyze the reaction.

Note that the amount of solvent required for interfacial polymerization can be relatively large (liters for grams of product), but the solvents can be recycled and reused again in the process. The solubility of the nanomaterials could limit the maximum concentration of them in the matrix, but can be compensated for by reducing the monomer concentrations to produce less polymer.

Variations on the present invention would include use of an emulsion polymerization process. In this process, the monomer and the nanomaterial would be dispersed in droplets in a water base, with the use of surfactants, and the polymerization will occur after adding a catalyst or initiator to the aqueous phase.

The polyamide nanotube (and functionalized nanotube) composites can also be synthesized by other polyamide synthesis techniques such as melt polymerization, with the nanotubes and/or functionalized nanotubes dispersed with the nylon salt and being integrated with the matrix during the polymerization. Another related variation is the direct polymerization of the nylon salt in a high boiling point solvent, in which the nanotubes and/or functionalized nanotubes will be dispersed in the solvent or in the nylon salt and incorporated into the polyamide during the synthesis.

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### EXAMPLE 1

This Example serves to generically illustrate how nanomaterial/polymer composites can be made via interfacial polymerization, in accordance with some embodiments of the present invention.

In some embodiments, methods for making nanomaterial/polymer composites via methods of the present invention can be described by the following steps: (Step 1) Disperse the nanomaterial in the organic phase. Prior to this, perform any chemical treatments necessary to make the nanoparticles soluble or suspendable in the organic phase. Adjust the concentration of the nanomaterial to achieve the desired concentration in the composite. (Step 2) Dissolve a quantity of one of the monomers in the aqueous phase together with a suitable base or other substance that will remove byproducts. Adjust the concentration to maximize yield. (Step 3) Add a quantity of the other monomer to the organic phase comprising the nanomaterial, chose a monomer concentration to maximize yield and/or control the final concentration of nanomaterial in the composite. (Step 4) Bring the two phases together with high shear stirring. Allow the monomers to react for a period of from two to a few minutes to achieve a complete reaction. (Step 5) Remove the slurry containing the composite from the reactor. (Step 6) Filter the composite. Wash with water and/or solvents as required to remove any byproducts and unreacted monomers. Repeat washing steps if required. (Step 7) The washed composite can be redissolved in a suitable solvent followed by a fiber spinning process. It is also possible to start the fiber spinning process from the original slurry and wash the composite of impurities during or after the spinning process. Alternatively, the composite can be dried and collected, with the resulting powder or pellets being suitable for conventional thermoplastic processing. (Step 8) Recover the solvents, and any unreacted monomers, for reuse in further synthesis.

Regarding the foregoing, the nanomaterial should be well dispersed in the organic phase to achieve good dispersion in the polymer matrix. The organic phase has to be immiscible with water, which means that in most cases non-polar solvents will be needed, and nanomaterials with a polar nature will disperse less effectively. The functionalization of nanomaterials with chemical groups that facilitate their dissolution or suspension in the organic phase can alleviate this problem. Additionally, chemical groups attached to the nanomaterials in such a way can be selected to enhance and control the interaction of the nanoparticles with the matrix.

### EXAMPLE 2

This Example serves to illustrate how SWNTs can be dispersed in nylon in accordance with embodiments of the present invention.

An aqueous solution is prepared with 2.32 g (0.02 mole) of hexamethylenediamine, NH₂(CH₂)₆NH₂, and 1.60 g (0.04 mole) of sodium hydroxide, NaOH. The solution is placed in a laboratory blender. Separately, 200 mg of SWNTs are dispersed in 250 mL of tetrachloroethylene. The suspension is place in an ultrasound bath for three hours to disperse the nanotubes. To the nanotube suspension is added 3.66 g (0.02 mole) of adipoyl chloride, ClCO(CH₂)₄COCl.

The blender is turned on to stir at 20,000 RPM, or a similar suitable speed, and the organic solution is rapidly added to the aqueous solution, and the reaction is allowed to proceed under stirring for at least 2 minutes and up to 8 minutes. The gray slurry containing the product is filtered through a fritted glass filter of medium or coarse porosity. The product is washed with deionized water to remove byproduct salts and unreacted monomers, is then washed with methanol or ethanol, and then washed with acetone to remove the solvent and other organic impurities, as well as to remove the water. As an option, the product can be finally washed with dry ethyl ether to remove more water. The wet powder obtained is then allowed to dry in air, or dried in a furnace at 90° C. for 3-5 hours, or it can be dried in a vacuum furnace.

The final product is a black powder or aggregate, and with the quantities of reactants and nanomaterials specified, about 2.5 g of the composite is produced. The composite incorporates single-wall carbon nanotubes with a concentration of about 8 wt. %, in Nylon-6,6, also known as poly(hexamethylenadipamide) or poly(hexamethylendiamine-co-adipic acid), with a polymer yield of about 61% of the theoretical. The concentration of SWNT in the composite can be easily adjusted with variation of their concentration in the organic solvent, or by changing the concentrations of monomers.

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. A method comprising the steps of:
a) suspending a quantity of nanomaterials in a polar solvent to form a polar suspension;
b) dissolving a quantity of a first monomer species in the polar suspension to form a polar reactant phase;
c) dissolving a quantity of a second monomer species in a non-polar solvent to form a non-polar reactant phase; and
d) contacting the polar reactant phase with the non-polar reactant phase so as to effect interfacial polymerization, wherein such interfacial polymerization yields a composite product comprising nanomaterials well-dispersed in a copolymer matrix.

2. The method of claim 1, wherein the nanomaterials are selected from the group consisting of carbon nanotubes, inorganic nanorods, fullerenes, ceramic nanoparticles, metallic nanoparticles, nanoclays, nanosheets, nanoshells, dendrimers, vapor grown carbon fibers, and derivatives and combinations thereof.

3. The method of claim 1, wherein the nanomaterials are carbon nanotubes selected from the group consisting of single-wall carbon nanotubes, multi-wall carbon nanotubes, double-wall carbon nanotubes, and derivatives and combinations thereof.

4. The method of claim 1, wherein the polar reactant phase and the non-polar reactant phase are immiscible with each other.

5. The method of claim 1, wherein the polar solvent is selected from the group consisting of water, alcohols, glycols, and combinations thereof.

6. The method of claim 1, wherein the non-polar solvent is selected from the group consisting of benzene, toluene, xylene, mesitylene, o-dichlorobenzene, tetrachloroethylene, and combinations thereof.

7. The method of claim 1, further comprising a surfactant to facilitate suspension of the nanomaterials.

8. The method of claim 1, wherein the first monomer species is selected from the group consisting of diamines, di-alcohols, diphenols, dithiols, and combinations thereof.

9. The method of claim 1, wherein the second monomer species is selected from the group consisting of dicarboxylic acid chlorides, disulfonyl chlorides, phosgene, bischloroformates, and combinations thereof.

10. The method of claim 1 further comprising a step of removing the solvent from the composite product.

11. The method of claim 10, wherein removing the solvent is accomplished via filtration.

12. The method of claim 10 further comprising a step of washing the composite product.

13. The method of claim 1 further comprising a step of fiber spinning the composite product.

14. The method of claim 1 further comprising a step of processing the composite product with traditional thermoplastic processing techniques.

15. A method comprising the steps of:
a) suspending a quantity of nanomaterials in a non-polar solvent to form a non-polar suspension;
b) dissolving a quantity of a first monomer species in the non-polar suspension to form a non-polar reactant phase;
c) dissolving a quantity of a second monomer species in a polar solvent to form a polar reactant phase; and
d) contacting the polar reactant phase with the non-polar reactant phase so as to effect interfacial polymerization, wherein such interfacial polymerization yields a composite product comprising nanomaterials well-dispersed in a copolymer matrix.

16. The method of claim 15, wherein the nanomaterials are selected from the group consisting of carbon nanotubes, inorganic nanorods, fullerenes, ceramic nanoparticles, metallic nanoparticles, nanoclays, nanosheets, nanoshells, dendrimers, vapor grown carbon fibers, and derivatives and combinations thereof.

17. The method of claim 15, wherein the nanomaterials are carbon nanotubes selected from the group consisting of single-wall carbon nanotubes, multi-wall carbon nanotubes, double-wall carbon nanotubes, and derivatives and combinations thereof.

18. The method of claim 15, wherein the polar reactant phase and the non-polar reactant phase are immiscible with each other.

19. The method of claim 15, wherein the polar solvent is selected from the group consisting of water, alcohols, glycols, and combinations thereof.

20. The method of claim 15, wherein the non-polar solvent is selected from the group consisting of benzene, toluene, xylene, mesitylene, o-dichlorobenzene, tetrachloroethylene, and combinations thereof.

21. The method of claim 15, further comprising a surfactant to facilitate suspension of the nanomaterials.

22. The method of claim 15, wherein the second monomer species is selected from the group consisting of diamines, di-alcohols, diphenols, dithiols, and combinations thereof.

23. The method of claim 15, wherein the first monomer species is selected from the group consisting of dicarboxylic acid chlorides, disulfonyl chlorides, phosgene, bischloroformates, and combinations thereof.

24. The method of claim 15 further comprising a step of removing the solvent from the composite product.

25. The method of claim 24, wherein removing the solvent is accomplished via filtration.

26. The method of claim 24 further comprising a step of washing the composite product.

27. The method of claim 15 further comprising a step of fiber spinning the composite product.

28. The method of claim 15 further comprising a step of processing the composite product with traditional thermoplastic processing techniques.

29. A method comprising the steps of:
a) suspending a quantity of nanomaterials in an organic solvent to form an organic suspension;
b) dissolving a quantity of a first monomer species in the organic suspension to form an organic reactant phase;
c) dissolving a quantity of a second monomer species in water to form an aqueous reactant phase; and
d) contacting the organic reactant phase with the aqueous reactant phase so as to effect interfacial polymerization, wherein such interfacial polymerization yields a composite product comprising nanomaterials well-dispersed in a polymer matrix.

30. The method of claim 29, wherein the nanomaterials are selected from the group consisting of carbon nanotubes, inorganic nanorods, fullerenes, ceramic nanoparticles, metallic nanoparticles, nanoclays, nanosheets, nanoshells, dendrimers, vapor grown carbon fibers, and derivatives and combinations thereof.

31. The method of claim 29, wherein the nanomaterials are carbon nanotubes selected from the group consisting of single-wall carbon nanotubes, multi-wall carbon nanotubes, double-wall carbon nanotubes, and derivatives and combinations thereof.

32. The method of claim 29, wherein the nanomaterials are chemically modified.

33. The method of claim 29, wherein the organic reactant phase and the aqueous reactant phase are immiscible with each other.

34. The method of claim 29, wherein the organic solvent is selected from the group consisting of aromatic solvents, chlorinated solvents, aliphatic solvents, and combinations thereof.

35. The method of claim 29 further comprising a surfactant to facilitate suspension of the nanomaterials.

36. The method of claim 29, wherein the second monomer species is selected from the group consisting of diamines, di-alcohols, diphenols, dithiols, and combinations thereof.

37. The method of claim 29, wherein the first monomer species is selected from the group consisting of dicarboxylic acid chlorides, disulfonyl chlorides, phosgene, bischloroformates, and combinations thereof.

38. The method of claim 29 further comprising a step of removing the solvent from the composite product.

39. The method of claim 38, wherein removing the solvent is accomplished via filtration.

40. The method of claim 38 further comprising a step of washing the composite product.

41. The method of claim 29 further comprising a step of fiber spinning the composite product.

42. The method of claim 29 further comprising a step of processing the composite product with traditional thermoplastic processing techniques.

43. A method comprising the steps of:
a) suspending a quantity of nanomaterials in an organic solvent to form an organic suspension;
b) dissolving a quantity of a bifunctional monomer species in the organic suspension to form an organic reactant phase;
c) dissolving a quantity of a reactant species in water to form an aqueous reactant phase to neutralize byproducts and/or catalyze the reaction; and
d) contacting the organic reactant phase with the aqueous reactant phase so as to effect interfacial polymerization, wherein such interfacial polymerization yields a composite product comprising nanomaterials well-dispersed in a polymer matrix.

44. The method of claim 43, wherein the nanomaterials are selected from the group consisting of carbon nanotubes, inorganic nanorods, fullerenes, ceramic nanoparticles, metallic nanoparticles, nanoclays, nanosheets, nanoshells, dendrimers, vapor grown carbon fibers, and derivatives and combinations thereof.

45. The method of claim 43, wherein the nanomaterials are carbon nanotubes selected from the group consisting of single-wall carbon nanotubes, multi-wall carbon nanotubes, double-wall carbon nanotubes, and derivatives and combinations thereof.

46. The method of claim 43, wherein the nanomaterials are chemically modified.

47. The method of claim 43, wherein the organic reactant phase and the aqueous reactant phase are immiscible with each other.

48. The method of claim 43, wherein the organic solvent is selected from the group consisting of aromatic solvents, chlorinated solvents, aliphatic solvents, and combinations thereof.

49. The method of claim 43 further comprising a surfactant to facilitate suspension of the nanomaterials.

50. The method of claim 43, wherein the bifunctional monomer species comprises a first functional moiety selected from the group consisting of amines, alcohols, phenols, thiols, and combinations thereof.

51. The method of claim 43, wherein the bifunctional monomer species comprises a second functional moiety selected from the group consisting of carboxylic acid chlorides, sulfonyl chlorides, and combinations thereof.

52. The method of claim 43 further comprising a step of removing the solvent from the composite product.

53. The method of claim 52, wherein removing the solvent is accomplished via filtration.

54. The method of claim 52 further comprising a step of washing the composite product.

55. The method of claim 43 further comprising a step of fiber spinning the composite product.

56. The method of claim 43 further comprising a step of processing the composite product with traditional thermoplastic processing techniques.
